(19) United States
(12) Patent Application Publication
(10) Pub. No.: US 2007/0210597 A1
(43) Pub. Date: Sep. 13, 2007

(54) Width adjustable car barrier

(76) Inventor: Chiu-Kuei Wang, Dajia Town (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/713,712

(22) Filed: Mar. 5, 2007

(30) Foreign Application Priority Data
Mar. 7, 2006 (TW) 095203764

(51) Int. Cl. B60R 7/00; B60P 3/04

(52) U.S. Cl. 296/24.43; 119/412

(57) ABSTRACT

A car barrier includes two posts and a central net is connected between the two posts. Two side nets are slidably connected to two ends of the central net. The central net has a first top rail and a first bottom rail, and each of the side nets has a second top rail and a second bottom rail. At least one positioning unit has a connection member which includes two passages defined therethrough. The first bottom rail and the second bottom rail respectively extend through the two passages. The second bottom rails can be slid with in the passages so as to adjust the width of the car barrier.

### FIELD OF THE INVENTION

The present invention relates to a car barrier having two side portions which are adjustably moved in horizontal direction so as to set a desired width of the car barrier.

### BACKGROUND OF THE INVENTION

A conventional car barrier 50 is shown in FIGS. 4 to 6, and generally includes two posts 40 and a central net 51 is connected between the two posts 40 and two side nets 52 are connected to two ends of the central net 51 by a plurality of securing units 60. Each of the central net 51 and the two side nets 52 is composed of longitudinal wires and latitude wires 54. Each securing unit 60 includes a first part 61 and a second part 63, wherein the first part 61 has two sidewalls 62 between which two respective longitudinal wires 53 of the overlapped central net 51 and one of the side nets 52 are located. The second part 63 is located on the other side of the overlapped central net 51 and one of the side nets 52 and located between the two sidewalls 62. A bolt extends through the first and second parts 61, 63 and is connected with a nut. Although the two side nets 52 can be adjusted relative to the central net 51, it takes a lot of time to unscrew the bolt of each of the securing units 60 and remove all of the securing units 60 from the central and side nets 51, 52. The side nets 52 are then re-position to desired positions relative to the central net 51, and then the nuts are connected to the bolts one by one. During the adjustment, the user has to hold the side net 52 by one hand and use the other hand to connect the bolt and the nut. Obviously, this is not an easy task for some of the users.

The present invention intends to provide a barrier which includes a central net and two side nets which are slidably connected to the central net by positioning members. The side nets do not remove from the central net and can conveniently slid to desired positions.

### SUMMARY OF THE INVENTION

The present invention relates to a car barrier that comprises two posts and a central net is connected between the two posts. Each post has an outer tube, an upper inner tube retractably connected to a top of the outer tube and a bottom inner tube retractably connected to a bottom of the outer tube. Two side nets are slidably connected to two ends of the central net. The central net has a first top rail and a first bottom rail, and each of the side nets has a second top rail and a second bottom rail. At least one positioning unit has a connection member which includes two passages defined therethrough. The first bottom rail and the second bottom rail respectively and slidably extend through the two passages.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the car barrier of the present invention;

FIG. 2 is an exploded view to show the securing unit for connecting the side net and the central net of the car barrier of the present invention;

FIG. 3 shows that the side net is slidably relative to the central net;

FIG. 4 is a perspective view to show a conventional car barrier;

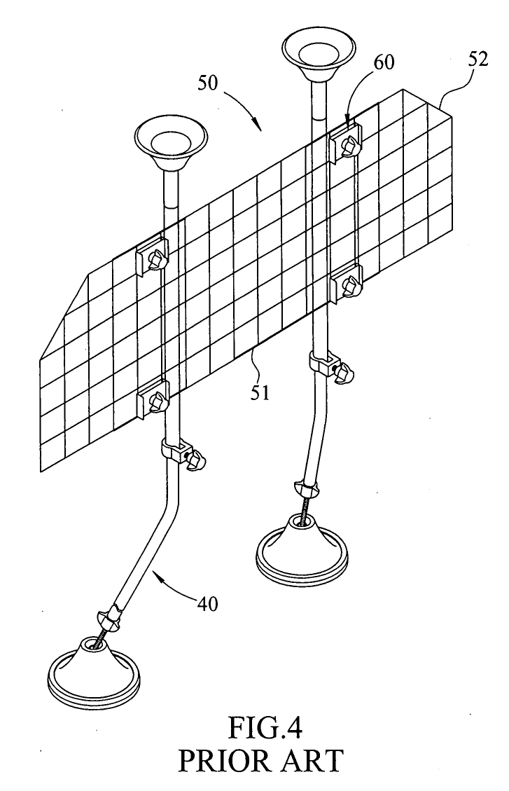

FIG. 5 is an exploded view to show the connection device for connecting the side net and the central net of the conventional car barrier, and

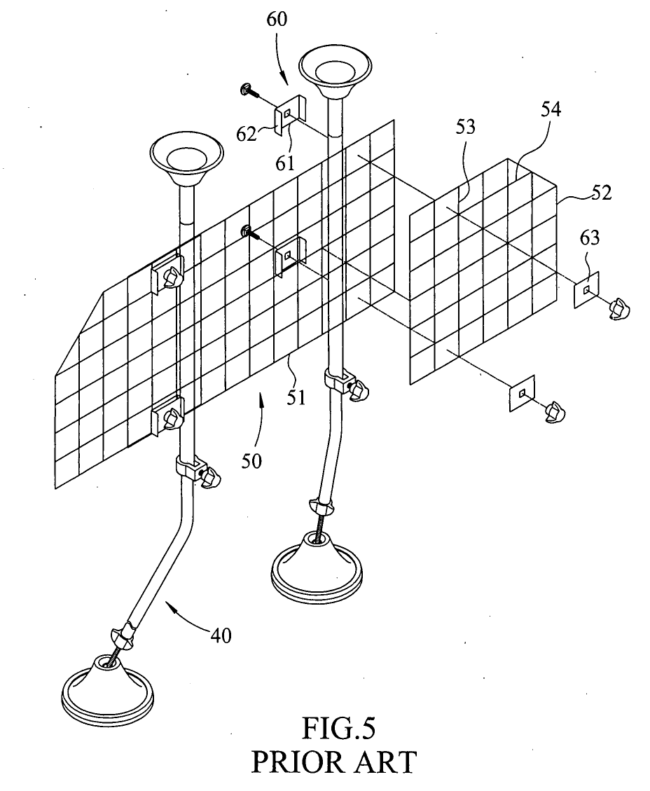

FIG. 6 shows that the two side nets are slidable relative to the central net of the conventional car barrier.

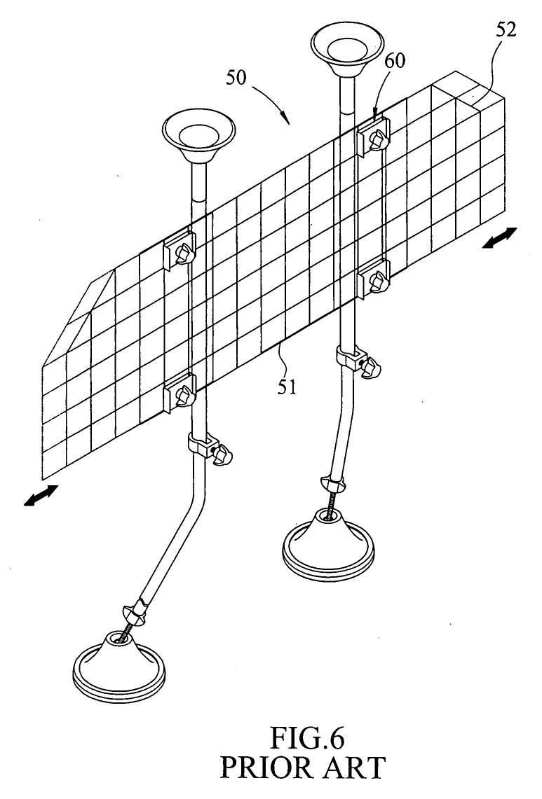

### DETAILED DESCRIPTION OF THE PREFERRED EMBODIMENT

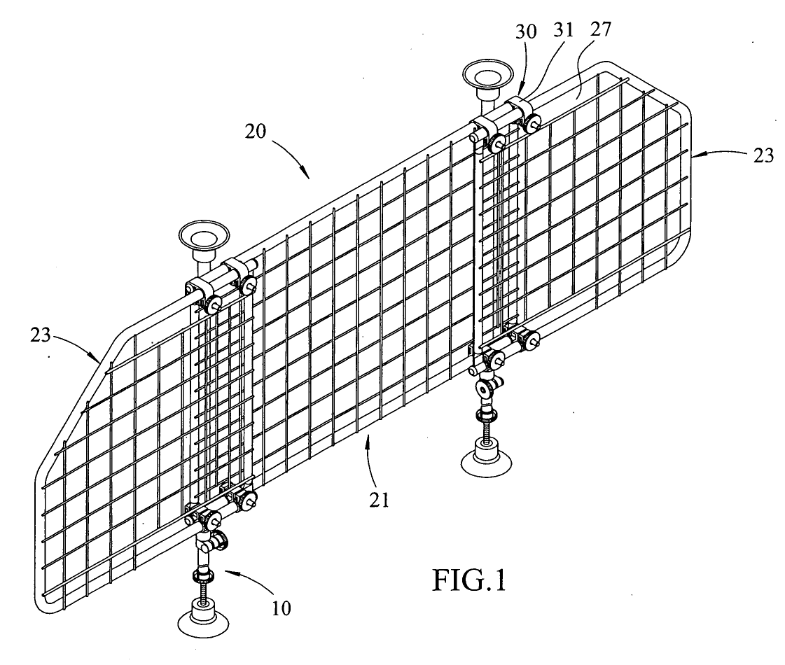

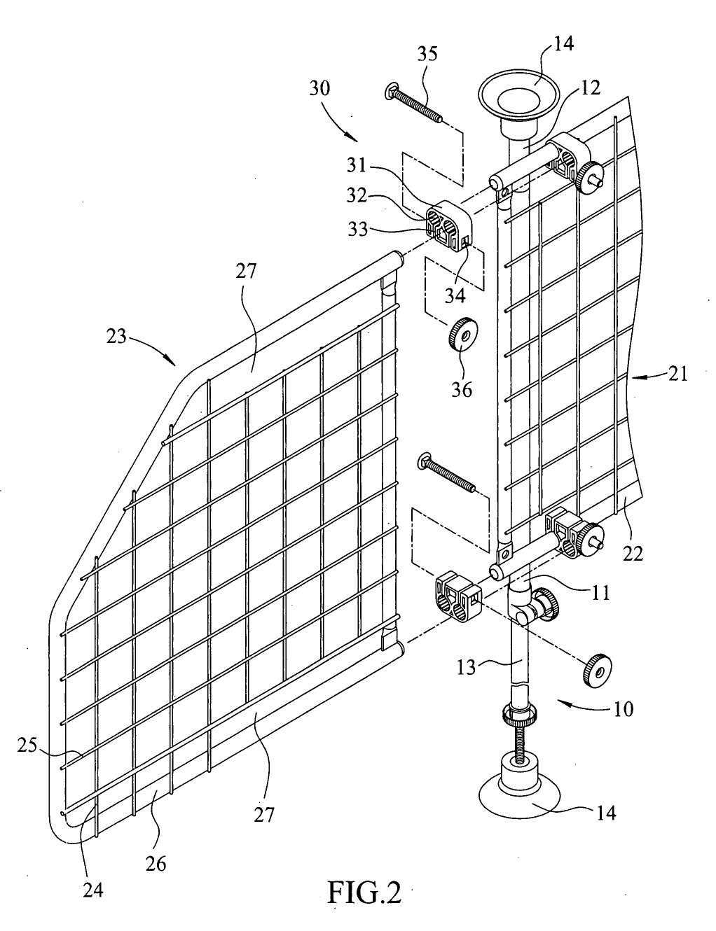

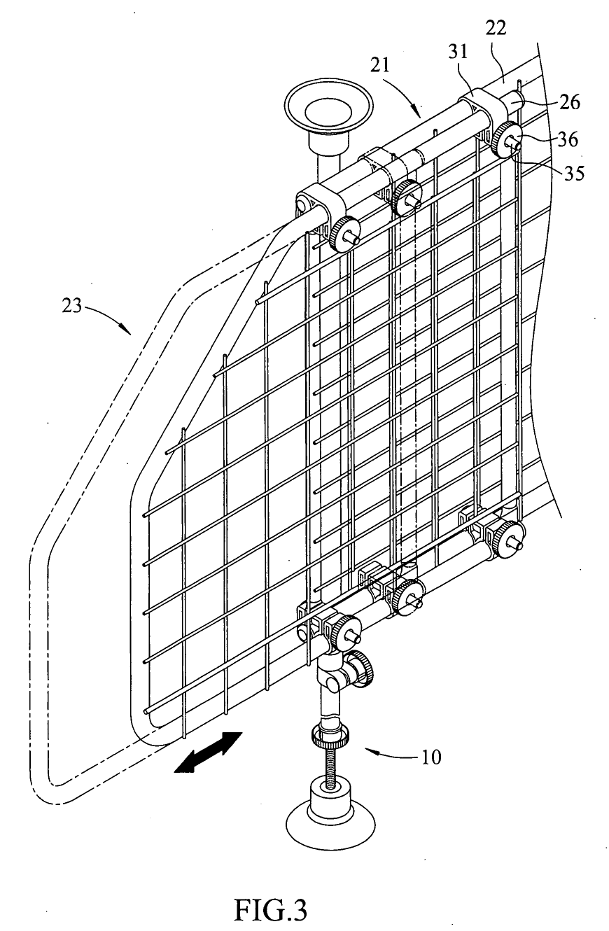

Referring to FIGS. 1 to 3, the car barrier 20 of the present invention comprises two posts 10 with a central net 21 connected between the two posts 10 and two side nets 23 are slidably connected to the central net 21. Each post 10 includes an outer tube 11, an upper inner tube 11 retractably connected to a top of the outer tube 11 and a bottom inner tube 12 retractably connected to a bottom of the outer tube 11. Each of the upper inner tube 11 and the bottom inner tube 12 has a suction member 14 connected thereto so as to be respectively in contact with the ceiling and the floor of the car. The central net 21 has a first top rail and a first bottom rail 22, between which a plurality of longitudinal wire 24 and latitude wires 25 are connected. Similarly, each of the side nets 22 has a second top rail and a second bottom rail 26, and a plurality of longitudinal wire 24 and latitude wires 25.

Two positioning units 30 each have a connection member 31 which is made by plastic material so as to provide proper flexibility and includes two passages 32 defined therethrough. Two slots 33 are defined in the connection member 31 and communicate with the two passages 32 respectively so that the passages 32 are allowed to be narrowed due to the flexibility of the plastic material. A through hole 34 is defined through the connection member 31 and communicates with the two slots 33 perpendicularly,

The first top rail and the second top rail respectively extend through the two passages 32 of the connection member 31 at the top edge of the car barrier 20, and the first bottom rail 22 and the second bottom rail 26 respectively extend through the two passages 32 at the lower edge of the car barrier 20. A bolt 35 extends through the through hole 34 of each of the two connection members 31 and is connected with a nut 36. The two passages 32 and slots 33 are narrowed by the bolt 35 and the nut to securely clamp the first and second top rails and the first and second bottom rails 26 to position the side nets 23 relative to the central net 21.

When the width of the car barrier 20 needs to be adjusted, the user simply rotates the nuts 36 to slightly loosen the narrowed passages 32 and the slots 33, the second top rail and the second bottom rail 26 of the side nets 23 can be slidable relative to the central net 21. When the nuts 36 are rotated to lock the connection members 31 again, the side nets 23 are positioned at new positions.

It is noted that each of the side nets 23 includes two spaces 27 located beside the second top rail and the second bottom rail 26 respectively. No longitudinal wire 24 and latitude wires 25 are existed in the two spaces 27 so that when sliding the side nets 23, no longitudinal wire 24 and latitude wires 25 tangle the insides of the slots 33.

While we have shown and described the embodiment in accordance with the present invention, it should be clear to those skilled in the art that further embodiments may be made without departing from the scope of the present invention.

What is claimed is:

1. A car barrier comprising:
two posts and a central net connected between the two posts, each post having an outer tube, an upper inner tube retractably connected to a top of the outer tube and a bottom inner tube retractably connected to a bottom of the outer tube, two side nets slidably connected to two ends of the central net, the central net having a first top rail and a first bottom rail, each of the side nets having a second top rail and a second bottom rail, and
at least one positioning unit having a connection member which includes two passages defined therethrough, the first bottom rail and the second bottom rail respectively extending through the two passages.

2. The barrier as claimed in claim 1, wherein two slots are defined in the connection member and communicate with the two passages respectively, a through hole is defined through the connection member and communicates with the two slots perpendicularly, a bolt extends through the through hole and is connected with a nut.

3. The barrier as claimed in claim 1, wherein connection member is made by plastic material so that the two passages and slots are narrowed by the bolt and the nut.
